(19) United States
(12) Patent Application Publication
(10) Pub. No.: US 2014/0358813 A1
(43) Pub. Date: Dec. 4, 2014

(54) SYSTEM AND METHOD FOR PROVIDING SCHOOL ADMISSION INFORMATION, AND RECORDING MEDIUM FOR THE METHOD

(71) Applicant: Keun Jin Kim, Seoul (KR)

(72) Inventor: Keun Jin Kim, Seoul (KR)

(21) Appl. No.: 14/369,239

(22) PCT Filed: Jun. 14, 2013
(86) PCT No.: PCT/KR2013/005267

§ 371 Date: Jun. 27, 2014

(30) Foreign Application Priority Data
Jun. 15, 2012 (KR) 10-2012-0064052

(51) Int. Cl. G06Q 10/10; G06Q 50/20

(52) U.S. Cl. CPC G06Q 10/10; G06Q 50/2053
USPC 705/327

(57) ABSTRACT

The present invention provides a school admission information providing system and method including: an applicant information database which statistically stores grade information of successful applicants for many years for every school or major; a grade information input unit which receives grade information including at least one of a GPA, a school admission test result, an award winning career, and an extracurricular activity; a grade evaluating unit which compares and analyzes grade information of the student and statistic information of the successful applicants stored in the applicant information database to calculate a level of the student for every item of the grade information and provide information on an acceptable school or major; and a feedback providing unit which provides learning contents or an extracurricular activity program for supplementing an insufficient item among the grade items of the student in accordance with the comparison and analysis result from the grade evaluating unit.

### TECHNICAL FIELD

The present invention relates to a school admission information providing system and method which provides various information on admission possibility for a desired school and major using grade information of a student.

### BACKGROUND ART

Regardless of what country you are from in the world, students everywhere desire to go to a better school. Specifically, in Korea, not only the students, but also the parents favor better education. Due to favoring a higher education, there are numerous cram schools and school admission related books to meet the demands, and in recent years, various education related businesses which provide various lectures through offline and online have been created.

In the meantime, according to a recent main trend, middle school, high school, and college admission processes do not evaluate a student only using a GPA(Grade Point Average) or an admission test result, but also select a student considering various factors such as award winning careers of a student, extracurricular activities, correlation with a desired major, a philosophy of the school, or contribution to the community of the student. For example, an admission officer system in the United States has been introduced and implemented for the admission process in Korea.

In this circumstance, a teacher or an expert such as an admission counselor may have limited personal capability and time in assessing different characteristics and strong points of individual students to accurately advise during the admission process for the best result. Accordingly, it is desired to develop a systemized system that comprehensively evaluates various factors such as a GPA, an admission test result, award winning careers, and extracurricular activities of the students of the student within a short time to provide school admission information optimal for individual students.

### DISCLOSURE

### Technical Problem

The present invention has been made in an effort to provide a school admission information providing system and method which comprehensively evaluates various grade information of a student to exactly determine admission possibility for a desired school or major and provides school admission information optimized for the individual students.

### Technical Solution

In order to achieve the above-mentioned object, an exemplary embodiment of the present invention provides a school admission information providing system, including: an applicant information database which statistically stores grade information of successful applicants for many years for every school or major; a grade information input unit which receives grade information including at least one of a GPA(Grade Point Average), a school admission test result, an award winning career, and an extracurricular activity; a grade evaluating unit which compares and analyzes grade information of the student and statistic information of the successful applicants stored in the applicant information database to calculate a level of the student for every item of the grade information and provide information on an acceptable school or major; and a feedback providing unit which provides learning contents or an extracurricular activity program for supplementing an item having insufficient grade of the student in accordance with the comparison and analysis result from the grade evaluating unit.

The school admission information providing system may further include a dream school information input unit which receives information on a dream school or an intended major of the student; and the school grade evaluating unit may further determine a chance of acceptance of the student for the dream school or the intended major based on the comparison and analysis result.

The school admission information providing system may further include a member management unit which registers the student as a member in accordance with a predetermined member joining form and authentication procedure and divides the level of the members so as to manage the grade evaluating unit and the feedback providing unit to provide information differentiated in accordance with a member level of the student.

The school admission information providing system may further include an SNS(Social Networking Service) interworking unit which provides an SNS function to allow the student to exchange information with a teacher, an admission consultant, and a student who currently goes to the dream school of the student.

The grade evaluating unit may compare and analyze the grade information of the student and successful applicant statistic information of the dream school or the intended major to notify a current level of the student for every grade item.

The feedback providing unit may provide learning contents or an extracurricular activity program of a grade item which needs to be supplemented for admission of the dream school or the intended major of the student.

Another exemplary embodiment of the present invention provides a school admission information providing method, including: statistically storing grade information of successful applicants for many years for every school or major; receiving grade information including at least one of a GPA(Grade Point Average), a school admission test result, an award winning career, and an extracurricular activity; comparing and analyzing grade information of the student and the stored statistic information of the successful applicants to calculate a level of the student for every item of the grade information and provide information on an acceptable school or major; and providing learning contents or an extracurricular activity program for supplementing an insufficient item of the grade items of the student in accordance with the comparison and analysis result.

The method may further include: receiving information on a dream school or an intended major of the student; and comparing and analyzing the grade information of the student and the stored statistic information of the successful applicants to determine a chance of acceptance of the student for the dream school or the intended major.

### Advantageous Effects

According to the present invention, various grade information such as a GPA, an admission test result, award winning careers, and extracurricular activities of a student is comprehensively analyzed to more objectively and exactly figure out a chance of acceptance for schools which evaluate the student based on various criterion.

Further, a strong point and a weak point of the student are figured out to recommend a school or a major which may emphasize the strong point and provide learning contents and extracurricular activity program information which may make up for the weak point to provide the students with an opportunity to attend a high ranking school.

Further, an SNS linked function is implemented to form a mentor network between the students and a teacher, an admission consultant, or seniors through an SNS, thereby more efficiently and continuously managing and improving the grades of the students.

Further, not only the individual students but also a teacher of the school or a private educational institute or a school admission related expert may more systematically manage the grades of the students.

### DESCRIPTION OF DRAWINGS

FIG. 1 is a schematic diagram of a network system in which a school admission information providing system according to an exemplary embodiment of the present invention is used.

FIG. 2 is a diagram of a school admission information providing system according to an exemplary embodiment of the present invention.

FIGS. 3 and 4 are flowcharts of a school admission information providing method using the school admission information providing system of FIG. 2.

FIGS. 5 to 10 are views illustrating examples of grade evaluation results and contents providing screens which are provided to students in the school admission information providing system according to the exemplary embodiment of the present invention.

### BEST MODE

The above-described objects, features and advantages will be described below in detail with reference to the accompanying drawings, and accordingly the technical spirit of the present invention may be easily implemented by those having ordinary skill in the art. When it is judged that specific description about known technologies related to the present invention may unnecessarily obscure the essentials of the present invention, the detailed description will be omitted. Hereinafter, preferred embodiments according to the present invention will be described in detail with reference to the accompanying drawings.

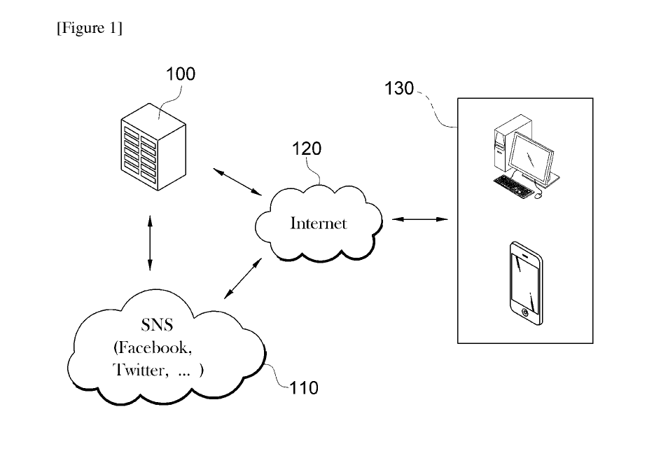

FIG. 1 is a schematic diagram of a network system in which a school admission information providing system according to an exemplary embodiment of the present invention is used.

As illustrated in FIG. 1, users access the Internet 120 using various types of user terminals 130 such as a personal PC or a smart phone and exchange various data with a school admission information providing system 100. The school admission information providing system 100 may collect various information from various users such as students, teachers, school admission related consultants, and admission officers through a specific web site installed on the Internet 120 and provide an analysis result thereof and various contents to the users.

Further, the school admission information providing system 100 interworks with a social network service (SNS) 110 such as Facebook or Twitter to provide an Internet community function to provide communication and information exchange between users, thereby maximizing the admission related consulting function.

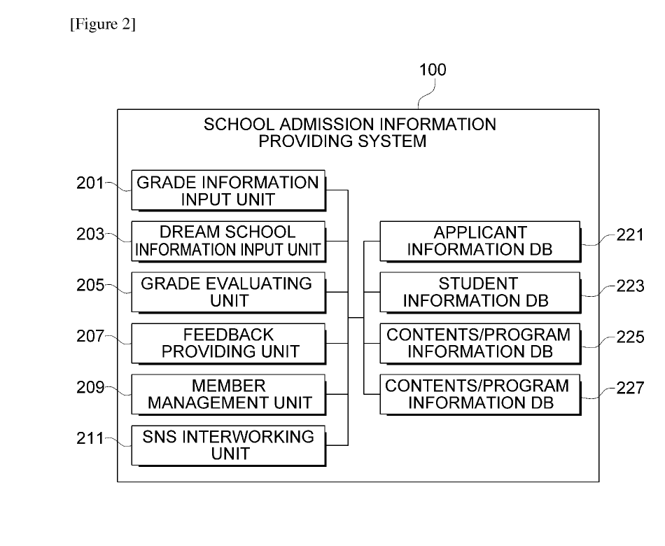

FIG. 2 is a diagram of a school admission information providing system according to an exemplary embodiment of the present invention.

Referring to FIG. 2, a school admission information providing system 100 according to an exemplary embodiment of the present invention includes a grade information input unit 201, a dream school information input unit 203, a grade evaluating unit 205, a feedback providing unit 207, a member management unit 209, an SNS interworking unit 211, an applicant information database (hereinafter, simply referred to as a “DB”) 221, a student information DB 223, a contents/program information DB 225, and a member information DB 227.

The grade information input unit 201 receives grade information including at least one of a GPA(Grade Point Average), an admission test result, an award winning career, and an extracurricular activity of a student who wants to get admission related information from a user. The GPA refers to grades from a school in which the student is currently enrolled (or graduated) and may include all grades from plural class subjects obtained for every school year. The admission test result refers to a result of an admission test which is taken for entering a specific school and in the case of a college admission process, test results such as a scholastic ability test result and an essay of the university in Korea and an SAT reasoning test, a SAT subject test, an AP exam, or TOEFL exam by the US may be included. If there is no confirmed admission test result, a mock test result may be replaced thereof. The award winning career refers to award careers won in various competitions in or out school or qualification tests. The extracurricular activity refers to a career such as various social activities or community services other than a normal school curriculum.

The dream school information input unit 203 receives information on a dream school or an intended major of the student. The user may directly write and input the dream school and the intended major of the student and also input a plurality of schools and majors. Further, the dream school information input unit 203 may create and provide a list of famous schools and a list of majors of each school so as to allow the user to easily select the school and the major. However, such a dream school information input unit 203 may be selectively provided and if no specific dream school or major is determined, the user may not input the related information.

Grade information of successful applicants for every school and major are statistically stored for many years in the applicant information DB 221. Specifically, information obtained by analyzing itemized results such as the GPA, the school admission test result, and the award winning career which are required in accordance with requirements of entrance examination for every school and major in accordance with a proportion and an average grade, a cut-off score, and a grade distribution of the successful applicants for every item are analyzed in various statistic methods to be stored. Further, information of students whose grades are newly evaluated are classified by items and stored and then an accepted school is determined later to be made as a database again so that most recent data may be continuously accumulated.

The grade evaluating unit 205 compares and analyzes the input grade information of the student and the successful applicant statistic information stored in the applicant information DB 221 to calculate a level of the student for every item of the grade information and provides information on a school and major expected at the grade level of the student. When the information on the dream school and the intended major of the student is input through the dream school information input unit 203, applicability and a chance of acceptance of the student are determined and provided based on the requirements of entrance examination of the school and the major.

In this case, in order to enhance fairness and objectivity of the evaluation for the GPA, an extra point or a deducted point may be applied to the grade point in accordance with a size and a name value of the school in which the student is currently enrolled. For example, a predetermined level of extra points may be added to the GPA of the student who is enrolled in a science high school or a famous foreign language high school.

When the award winning careers are evaluated, an extra point may be applied to the corresponding subject in accordance with a predetermined standard. The predetermined standard may include a regional scale of the competition and public confidence of a host organization and differentiated extra points may be applied in accordance with the regional scale and the public confidence. For example, a scale of the competition from which the student won an award is classified into a school level, a city level, a province level, a national wide level, and an international level and the larger the regional scale, the higher the extra points. Further, when the completion hosting organization is an education office or a government agency, the highest rank is applied, and a next highest rank is applied to the national or public university or a famous private university, and a next higher rank is applied to a corporation or a certified private organization and a higher extra point may be applied to a completion which is hosted by a higher ranked host organization.

The extracurricular activities are also evaluated by using a method of applying an extra point to a specific field comprehensively considering a regional range of the activity, a strong point of a leadership, and an importance of the result.

Further, the grade evaluating unit 205 may comprehensively consider the GPA, the admission test result, the award winning career, and the extracurricular activity of the student to determine a specialized field (for example, mathematics or science) or a weak part, that is, a strong point and a weak point of the corresponding student to be notified. Further, the grade evaluating unit 205 may provide various information on most preferable major to the student, famous universities in the major field, and a chance of acceptance of the student for the universities in accordance with the determined specialized field.

In the meantime, the information on the student which is input through the grade information input unit 201 and the dream school information input unit 203 and the results deducted from the grade evaluating unit 205 are all stored in the student information DB 223, which may allow a continuous and systemized school admission management for individual students.

The feedback providing unit 207 provides learning contents or an extracurricular activity program to make up for an insufficient item among the grade items of the student determined based on the evaluation result of the grade evaluating unit 205. Particularly, the feedback providing unit 207 may mainly provide learning contents to increase the chance of acceptance for the dream school or major, various competition information, or a special activity program such as summer camp, or community service. For example, when a student wants to major in mathematics at a specific university, but is evaluated that the grade of mathematics in the GPA of the student is lower than an average level of the successful applicants, learning contents related with mathematics is intensively provided.

The contents and program related information is stored in the contents/program information DB 225 and is continuously updated by a manager and the users.

The grade evaluating unit 205 and the feedback providing unit 207 may be divided into a lower grade module and a higher grade module. In the case of the lower grade module, grade data is not sufficient so that instead of providing the chance of acceptance for the university at the present time, acceptance criteria for every university are set for every factor, and various study plans, awards, and extracurricular activity opportunities are provided in order to reach the criteria. How close to a goal is analyzed at every a predetermined point of time later (for example, every month or every year) and a study progress result may be suggested. In the case of the higher grade module, it is more focused to calculate a chance of acceptance for the dream school based on the student grade data to the current time and provide optimal major and university information.

The member management unit 209 registers a student as a member in accordance with a predetermined member joining form and authentication procedure and divides the level of the members so as to manage the grade evaluating unit 205 and the feedback providing unit 207 to provide information differentiated in accordance with a member level of the student. For example, the members are divided into a charged member and a free member and the member management unit 209 provides only the grade evaluation result or some of the contents to the free member and induces the member to join as a charged member to earn a profit.

Further, when a teacher or a consultant of a school or a private educational institute is joined as a member, the member management unit 209 may provide a separate student management module in order to systematically and continuously manage the grades of their students.

The SNS interworking unit 211 provides an SNS function to allow the student to exchange information with the teacher, an admission consultant, or a student who goes to the dream school of the student. That is, the SNS interworking unit 211 helps the students to form a mentor-mentee relationship with the teacher, the consultant, or the senior student through the SNS such as Facebook. In this case, the mentors may directly create the contents by themselves to upload the contents to the system and the contents are classified by various criteria such as the university, the major, the subject, the award winning career, and the extracurricular activity to be stored in the contents/program information DB 225 and provided to students who want the contents.

Further, a question and an answer on all the SNS may be multi-tagged for every field by a tagging system and created as contents. Tags per field may be created to be subdivided into a subject, a dream school, an intended major, a type of test, an activity field, an award field, classification by university group, and an admission related terminology.

A material which is created as contents may be provided to the students as customized consulting or may be sold in the unit of contents or post. Further, a principal agent who provides contents such as a college student or a consultant may enumerate a graduated school, a major, a university application material, an essay sample, and an available lecture field, and utilizes an SNS platform to provide various admission related information, a video lecture, or an essay editing service to the students to earn a benefit. For example, a revenue model may be implemented such that when a person who posts contents as an answer for a question sets cost for viewing the contents, a student can see the posted contents only when the student pays the cost and some or all of the paid money excluding the handling fee is provided to the person who posts the answer.

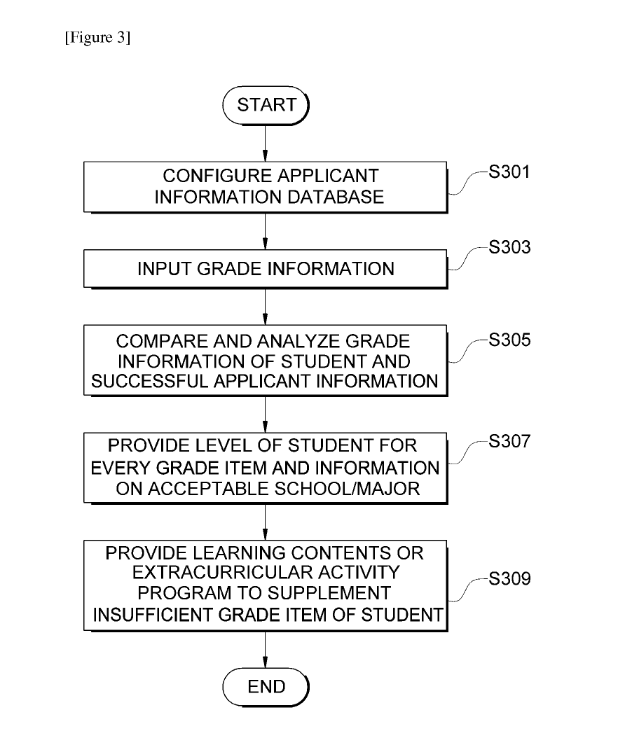

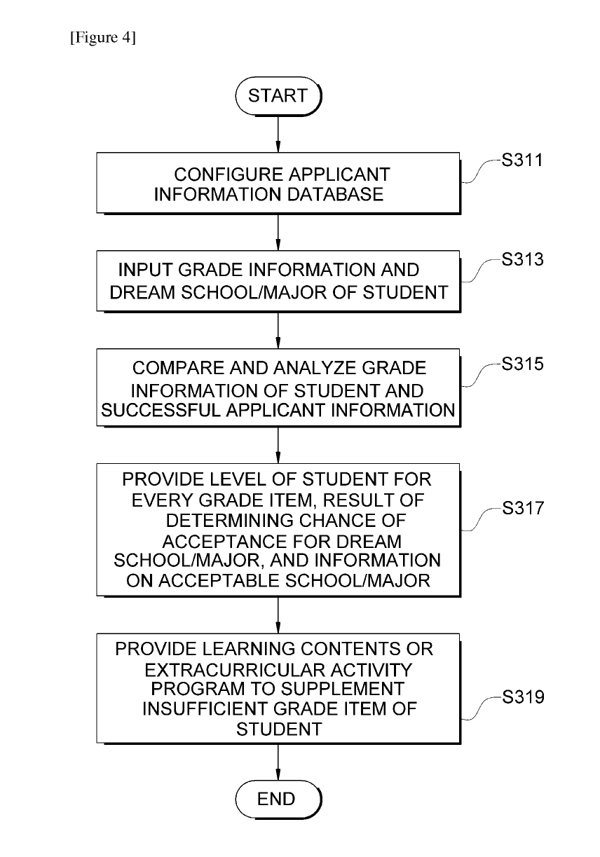

FIGS. 3 and 4 are flowcharts of a school admission information providing method using the school admission information providing system of FIG. 2.

Referring to FIG. 3, a school admission information providing method according to an exemplary embodiment of the present invention includes a step of configuring an applicant information database by statistically storing successful applicant grade information for many years for every school or major in step S301, a step of receiving grade information including at least one of a GPA, an school admission test result, an award winning career, an extracurricular activity of the student in step S303, a step of comparing and analyzing the input grade information of the student and successful applicant statistic information stored in the applicant information database in step S305, a step of calculating a level of the student for every grade item and providing information on an acceptable school or major in step S307, and a step of providing learning contents or an extracurricular activity program to supplement an insufficient grade item of the student in step S309.

Referring to FIG. 4, a school admission information providing method according to another exemplary embodiment of the present invention includes a step of configuring an applicant information database by statistically storing successful applicant grade information for many years for every school or major in step S311, a step of getting input grade information including at least one of a GPA, a school admission test result, an award winning career, an extracurricular activity of the student and information on a dream school or an intended major of the student in step S313, a step of comparing and analyzing the input grade information of the student and successful applicant statistic information stored in the applicant information database in step S315, a step of providing a result of calculating a level of the student for every grade item, a result of determining a chance of acceptance for the dream school or major, and information on an acceptable school or major in step S317, and providing learning contents or an extracurricular activity program to supplement an insufficient grade item of the student in step S319.

Here, the GPA refers to grades from a school in which the student is currently enrolled (or graduated) and the admission test result refers to a result of an admission test which is taken for entering a specific school. Further, the award winning career refers to award careers won in various competitions in or out school or qualification tests and the extracurricular activity refers to a career such as various social activities or community services other than the normal school curriculum.

A more specific grade evaluating method or information providing method in each step is the same as the above description with reference to FIG. 2.

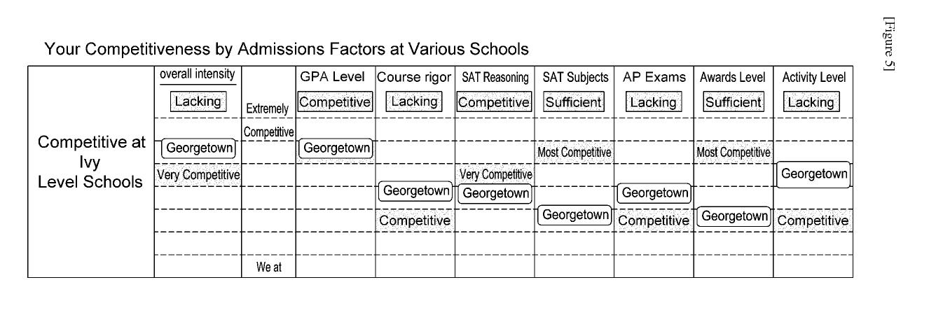

FIGS. 5 to 10 are views illustrating examples of grade evaluation results and contents providing screens which are provided to students in the school admission information providing system according to the exemplary embodiment of the present invention and the example screens are configured for students who want to go to universities in the United States.

FIG. 5 is a view illustrating a level calculated for every grade item of a student and a result of comparing the calculated level with a required level for a dream school (for example, Georgetown). The level is divided from “extremely competitive” to “weak” and a current position of the student is represented for every item so that an excellent item and an insufficient item of the student are determined at a glance. Further, levels of the grade items of successful applicants of the Georgetown University which is the student's dream school are also represented so that parts to be supplemented for entering the dream school are immediately noticed.

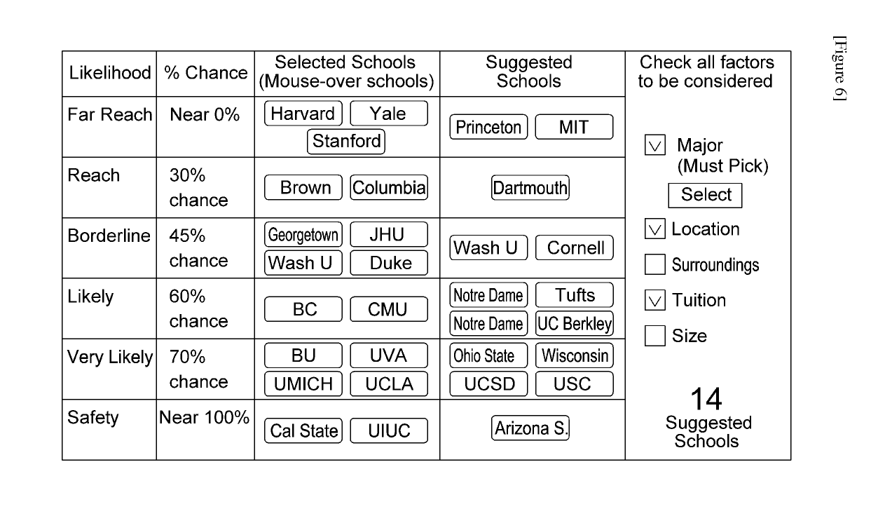

FIG. 6 is a view illustrating a chance of acceptance for the dream school selected by the student and schools recommended by the system. As illustrated in FIG. 6, the plurality of selected dream schools is grouped into schools having similar a chance of acceptance based on the current grade information of the student and the chance of acceptance may be represented by percentage.

Further, recommended schools among the unselected schools may be suggested together. Here, a mouse curser is moved to the list of the schools (mouse over) to implement a page so as to show an average point of the successful applicants of the school and a cutoff point.

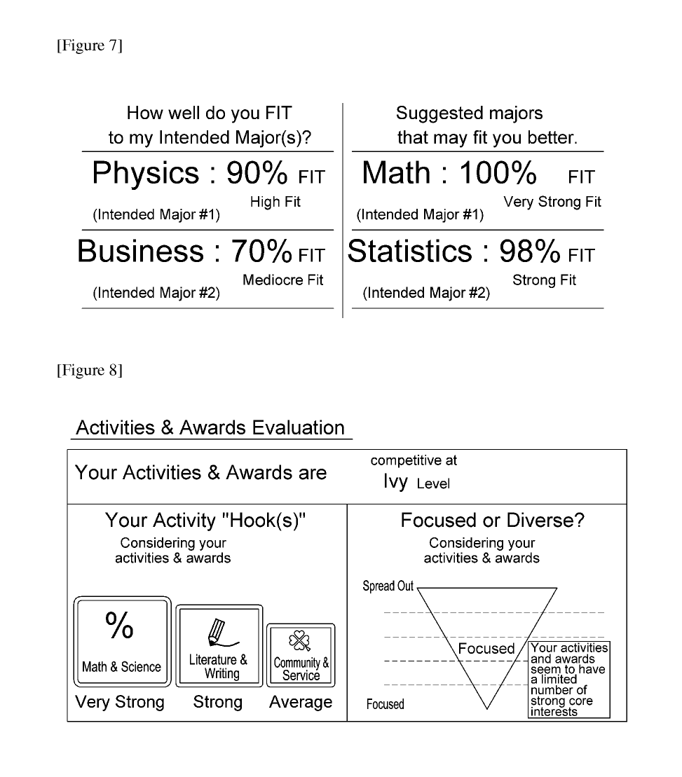

FIG. 7 is a view illustrating a result showing how the major selected based on the analysis result of the grade information of the student is fit to a characteristic of the student and the most preferable major.

FIG. 8 is a view illustrating a screen that shows an acceptable school level, an excellent subject, and an insufficient subject obtained by analyzing the GPA and the admission test result of the student in depth.

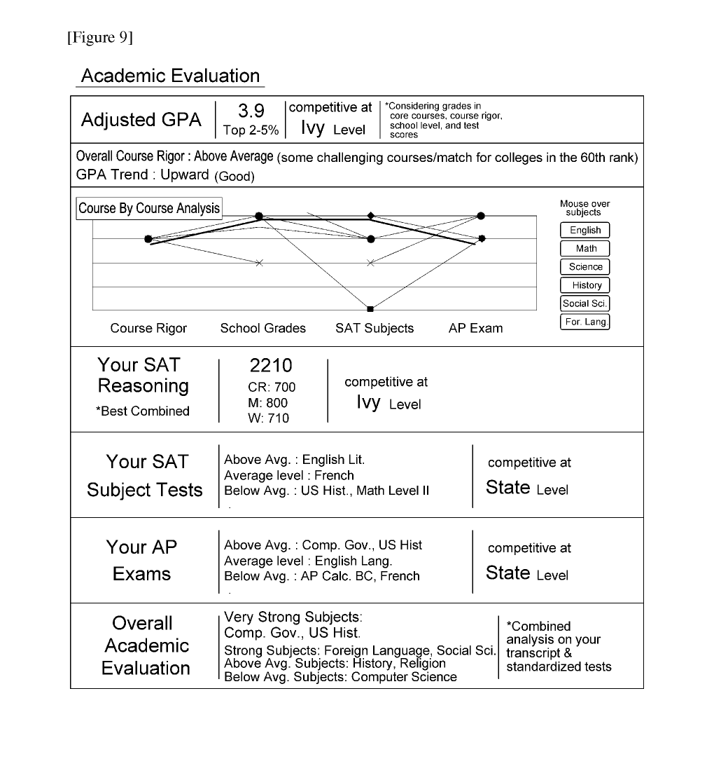

FIG. 9 illustrates as a result of evaluating what is a specialized field (Hook) of the student and whether the student has a strong point in a specific field or a broad field as a result of evaluating the award winning career and the extracurricular activity of the student.

As described above, the in-depth analysis result is provided for every grade item so that the student can determine the strong point and a weak point.

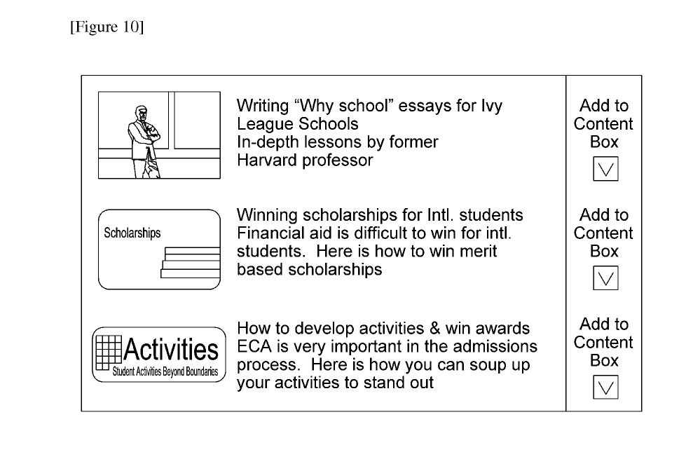

FIG. 10 is a view illustrating learning contents and extracurricular activity program information which are provided to the student. Such contents may be created and provided by the student who is enrolled in a specific school or a senior such as a graduate and a mentor network may be formed between juniors and seniors by interworking the SNS function.

In the meantime, the school admission information providing method according to the exemplary embodiment of the present invention may be stored in a computer readable recording medium. The recording medium includes all types of recording media in which a program and data are stored so as to be readable by a system implemented by a computer. For example, the recording medium may include a read only memory (ROM), a random access memory (RAM), a compact disk (CD), a digital video disk (DVD), a flash memory, a magnetic tape, a floppy disk, and an optical data storage device and also include a carrier wave type recording medium (for example, transmission through the Internet). Further, the recording medium is distributed to computer systems connected through a network, so that a computer readable code may be stored and executed by a distribution method.

The technical spirit of the present invention has been specifically described according to the preferred embodiments, but it is to be noted that the embodiments are provided for the description thereof and are not for the limitation thereof. In addition, it is obvious to those having ordinary skill in the art that various modifications may be made to the embodiments within the scope of the technical spirit of the present invention.

### INDUSTRIAL APPLICABILITY

According to the present invention, various grade information such as a GPA, an admission test result, award winning careers, and extracurricular activities of a student is comprehensively analyzed to more objectively and exactly figure out an admission possibility for a school which evaluates the student based on various grade criteria. Therefore, the present invention surpasses the limit of the existing technology and also has industrial applicability because the applied device has not only sufficient availability to be marketable and business possibility including the usage of the related technology and but also practical enablement.

1. A school admission information providing system, comprising:
an applicant information database which statistically stores grade information of successful applicants for many years for every school or major;
a grade information input unit which receives grade information including at least one of a GPA(Grade Point Average), a school admission test result, an award winning career, an extracurricular activity of a student;
a grade evaluating unit which compares and analyzes grade information of the student and statistic information of the successful applicants stored in the applicant information database to calculate a level of the student for every item of the grade information and provide information on an acceptable school or major; and
a feedback providing unit which provides learning contents or an extracurricular activity program for supplementing an item having insufficient grade of the student in accordance with the comparison and analysis result from the grade evaluating unit.

2. The school admission information providing system of claim 1, further comprising:
a dream school information input unit which receives information on a dream school or an intended major of the student,
wherein the grade evaluating unit further determines a chance of acceptance of the student for the dream school or the intended major based on the comparison and analysis result.

3. The school admission information providing system of claim 2, wherein the grade evaluating unit compares and analyzes the grade information of the student and successful applicant statistic information of the dream school or the intended major to notify a current level of the student for every grade item.

4. The school admission information providing system of claim 2, wherein the feedback providing unit provides learning contents or an extracurricular activity program of a grade item which needs to be supplemented for admission of the dream school or the intended major of the student.

5. The school admission information providing system of claim 1, further comprising:
a member management unit which registers the student as a member in accordance with a predetermined member joining form and authentication procedure and divides the level of the members so as to manage the grade evaluating unit and the feedback providing unit to provide information differentiated in accordance with a member level of the student.

6. The school admission information providing system of claim 1, further comprising:
an SNS(Social Networking Service) interworking unit which interworks with a specific SNS site to provide an internet community function to allow the student to exchange information with at least one of the teacher, an admission consultant, or a student who goes to the dream school of the student.

7. The school admission information providing system of claim 6, wherein the SNS interworking unit multi-tags a question and an answer on the SNS site for every field to be created as contents and provides the contents to the students as a customized consulting format.

8. A school admission information providing method, comprising:
statistically storing grade information of successful applicants for many years for every school or major;
receiving grade information including at least one of a GPA(Grade Point Average), a school admission test result, an award winning career, and an extracurricular activity;
comparing and analyzing grade information of the student and the stored statistic information of the successful applicants to calculate a level of the student for every item of the grade information and provide information on an acceptable school or major; and
providing learning contents or an extracurricular activity program for supplementing an insufficient grade item of the student in accordance with the comparison and analysis result.

9. The school admission information providing method of claim 8, further comprising:
receiving information on a dream school or an intended major of the student; and
comparing and analyzing the grade information of the student and the stored statistic information of the successful applicants to determine a chance of acceptance of the student for the dream school or the intended major.

10. (canceled)
